(19) United States
(12) Patent Application Publication
(10) Pub. No.: US 2004/0016300 A1
(43) Pub. Date: Jan. 29, 2004

(54) Multi-layered mechanical stress detection and characterization system

(76) Inventor: Markus Hugenschmidt, Munchen (DE)

Correspondence Address: Robert P. Renke, Suite 250, 28333 Telegraph Road, Southfield, MI, 48034, US

(21) Appl. No.: 10/423,071

(22) Filed: Apr. 25, 2003

(30) Foreign Application Priority Data
Apr. 25, 2002 (DE) DE 102 18 613.8

(51) Int. Cl. G01L 1/00

(52) U.S. Cl. 73/763

(57) ABSTRACT

A mechanical stress detection and characterization sensor (14) includes multiple test layers (32) that overlap each other. Multiple electrodes (36) are electrically coupled to the test layers (32). Electrical properties of one or more of the test layers (32) changes in response to loading of the mechanical stress detection and characterization sensor (14).

### TECHNICAL FIELD

The present invention relates to mechanical stress detection systems, and more particularly to a system for detecting and characterizing mechanical stresses within a mechanical system under various loading conditions.

### BACKGROUND OF THE INVENTION

Mechanical systems in industry generally experience mechanical stresses due to a variety of different loading conditions. Knowledge of these mechanical stresses is desirable in evaluation and testing of various system components as well as for other load detection and characterization purposes.

In designing a seat system of a vehicle, for example, it is desirable to have knowledge of typical loading conditions that may be experienced by the seat system in various operating environments. To obtain such knowledge the seat system may undergo extensive testing and evaluation, including performance evaluation of various mechanical and material components contained therein. The more a designer is aware of the intended operating environments of the seat system and the stresses experienced by the seat system, the better the seat system can be tailored or designed to withstand such environments and maintain seat system integrity.

Current mechanical load or force detection devices exist and are capable of providing a limited amount of information as to the stresses experienced by a mechanical system. The current force detection systems typically provide detection of variations in electrical properties of conductive materials contained within a mechanical system during loading conditions.

One force detection system is provided in German Patent No. DE 197 50 671 to Weis Karsten. Karsten provides a mechanical force-measuring sensor that monitors change in electrical properties of a foam material, which is conductive, when subjected to an applied load. Resistance of the foam material changes with change in applied load. The sensor includes an epoxy board that has etched or conductive electrodes.

Karsten, as well as other mechanical force detection devices, provides an apparatus for detecting an applied load. Depending on the number of sensors or stress detection devices used, an approximate location of the load may also be determined. Unfortunately, Karsten and the other known devices are limited in that they do not provide information with respect to nature of a load or forces exerted on a mechanical system and action of the load over a large surface area.

For example, with respect to a seat system, an individual may kneel or sit in a seat system and in each situation exert the same overall load, but create a different load distribution, and cause different compression and bending forces on the seat system. Current detection devices provide information corresponding to the overall load, but are incapable of providing information describing the nature of the compression and bending forces and resulting stresses on the seat system.

It is therefore desirable to develop a mechanical stress detection device that not only provides information regarding the overall applied load and approximate location of the applied load, but also provides information as to whether a load is isolated or distributed over an applied loading area of a device, as well as whether components of a mechanical system are experiencing elongation, compression, or bending forces during a loading event and amounts thereof.

### SUMMARY OF THE INVENTION

The present invention provides a system for detecting and characterizing mechanical stresses within a mechanical system under loading conditions. A mechanical stress detection and characterization sensor is provided. The stress detection system includes multiple test layers that overlap each other. Multiple electrodes are electrically coupled to the test layers. Electrical properties of one or more of the test layers changes in response to loading of the mechanical stress detection and characterization sensor.

One of several advantages of the present invention is that it provides a stress detection system that is capable of determining nature of an applied force. In so doing, the present invention is capable of detecting and characterizing elongation, compression, and bending forces or some combination thereof.

Another advantage of the present invention is that it is capable of detecting change in applied force over a large surface area.

Furthermore, the present invention is simple to manufacture and monitor.

Moreover, the present invention provides a simple design that is formed and arranged such that it is unnoticeable in soft material applications.

Yet another advantage of the present invention is that it is versatile in that it may be adapted to many mechanical system applications.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a perspective view of a seat system incorporating use of a mechanical stress detection and characterization system in accordance with an embodiment of the present invention;

FIG. 2 is a cross-sectional view of a mechanical stress detection and characterization sensor in accordance with an embodiment of the present invention;

FIG. 3 is a cross-sectional view of a mechanical stress detection and characterization sensor in accordance with multiple embodiments of the present invention; and

FIG. 4 is a top view of a pair of meandering electrodes coupled to a test layer of a mechanical stress detection and characterization sensor in accordance with another embodiment of the present invention.

### DESCRIPTION OF THE PREFERRED EMBODIMENT(S)

In the following figures the same reference numerals will be used to refer to the same components. While the present invention is described with respect to a system for detecting and characterizing mechanical stresses within a mechanical system, the present invention may be adapted and applied to various other systems known in the art.

In the following description, various operating parameters and components are described for one constructed embodiment. These specific parameters and components are included as examples and are not meant to be limiting.

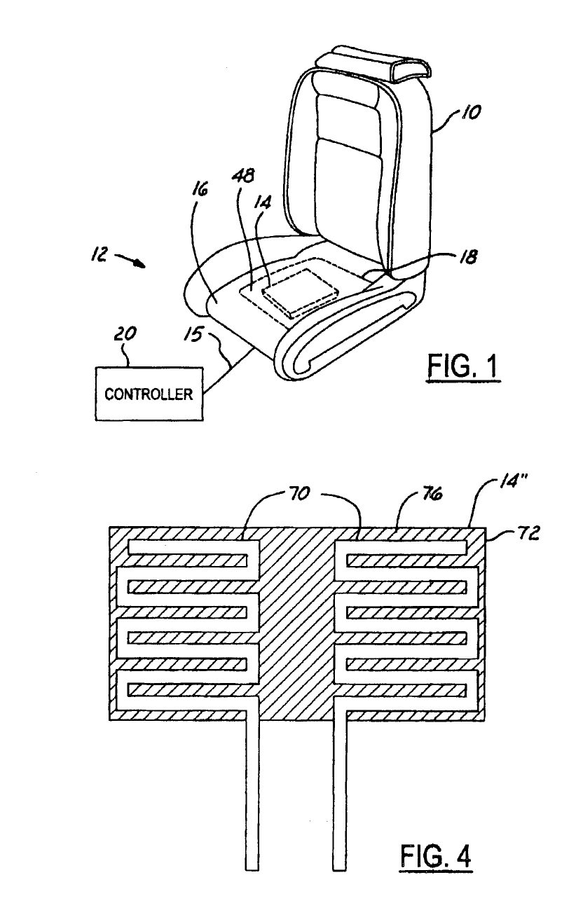

Referring now to FIG. 1, a perspective view of a seat system 10 incorporating a mechanical stress detection and characterization system 12 in accordance with an embodiment of the present invention is shown. The seat system 10 is shown for example purposes only to illustrate one possible mechanical system and one possible soft material application, but the present invention is not limited in application to a seat system and to a soft material application.

The stress detection system 12 includes a mechanical stress detection and characterization sensor 14 that is incorporated and coupled within seat pan material 16 covering a seat pan 18 of the seat system 10. A controller 20 is electrically coupled to the sensor 14, via a conductive cable 15, and detects and characterizes applied forces that are exerted on the sensor 14. The applied forces may be characterized as elongated forces, compression forces, bending forces, or a combination thereof. Distribution and change or action of the applied forces may also be monitored to provide information, such as detection of an object in the seat system 10, weight of the object, size of the object, position of the object, or other object information that may be used in performing vehicle tasks. Of course, an object may refer to an occupant or some other animate or inanimate object.

The sensor 14 is formed of flexible relatively soft materials so as to have approximately similar flexibility and stiffness characteristics of the seat pan material 16, thereby, the present invention provides a sensor that may be used in upholstery of a seat system and may be located near an upper surface of the upholstery without being physically and objectionably noticeable to an occupant of the seat system, as is illustrated in FIG. 1. Any number of the sensors 14 may be used in a given application and the sensors may be of various shape, style, and size.

The controller 20 may monitor multiple stresses, resulting from one or more applied forces, separately or simultaneously. Although, the controller is preferably microprocessor based such as a computer having a central processing unit, memory (RAM and/or ROM), and associated input and output buses, the controller 20 may simply be formed of logic state machines or of other logic devices known in the art. The controller 20 may be a portion of a central main control unit, an electronic control module, or may be a stand-alone controller, as shown.

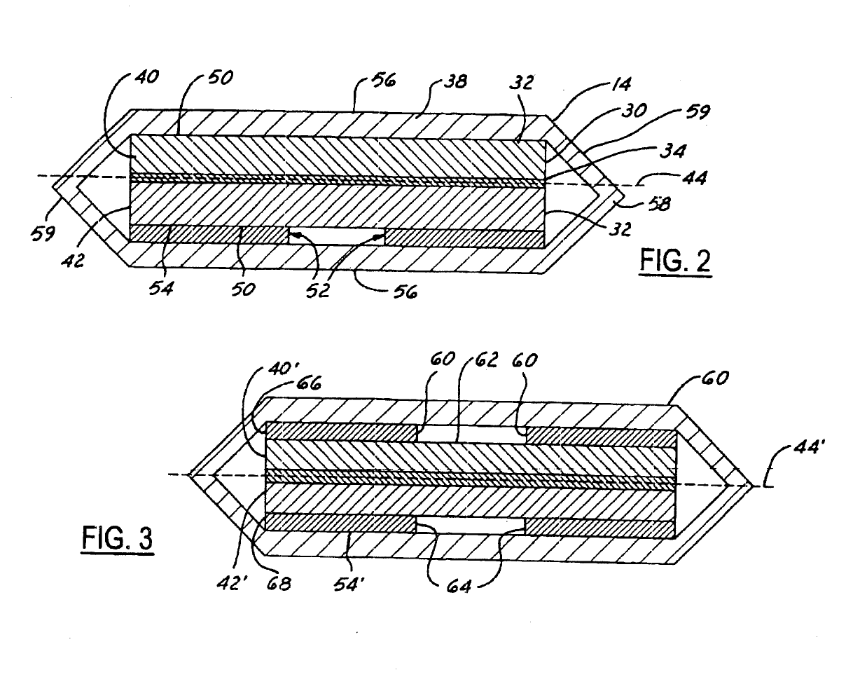

Referring now to FIG. 2, a cross-sectional view of the sensor 14 in accordance with an embodiment of the present invention is shown. The sensor 14 includes a test plate 30 having two or more electrically conductive test layers 32 and one or more interlayers 34 (only one is shown). The interlayers 34 are electrically coupled between the test layers 32. Two or more electrodes 36 are electrically coupled to the test layers 32. A housing 38 envelops or encases the test plate 30 and at least a portion of the electrodes 36.

The test layers 32 at least partially overlap each other, exhibit a finite electric resistance, and at least one of the test layers 32 is compressible. To further distinguish between various applied forces on the sensor 14, portions of the test layers 32 may be arranged as to not overlap, and the electrodes 36 may be coupled over the nonoverlapped portions, thus providing an additional load differentiating feature. In the embodiment of FIG. 2, an upper test layer 40 is less compressible than a bottom test layer 42, which is in contact with the electrodes 36.

The test layers 32 may be formed of material which is elastic, synthetic, amorphous, crystalline, foamed, or other material type known in the art or a combination thereof. In one embodiment of the present invention, materials contained in each of the test layers 32 have one or more common material properties. Utilizing materials that have known common material properties provides ease in using mathematical comparisons between the test layers 32. The material properties may include electrical conductivity, modulus of elasticity, flexural rigidity, variation of specific electrical conductivity or other material property known in the art. The material properties may change under force, loading, or thermal conditions as well as other material property altering conditions known in the art.

The stated test layer materials may contain electrically conductive particles. Under compression, the conductive particles come into contact with each other and increase electrical conductivity of a corresponding test layer. The particles may be of various type and style. The particles may be fibrous in nature and provide a fixed base conductivity. The particles may be granular and effect conductivity under pressure. The particles may be a mixture of multiple different particles, including fibrous, knots, grains, flocks, or other particle types known in the art.

The interlayers 34 separate the test layers 32 and preferably have greater electrical conductivity in a direction perpendicular to the interlayers 34 than in a direction parallel to an axis 44 extending along and parallel to the interlayers 34. In this manner, the interlayers 34 have altering properties that react more in response to stresses in the direction perpendicular to the axis 44 and less for stresses parallelly exerted along the axis 44, which aids in determining direction of applied forces or resulting stresses. The interlayers 34 also exhibit a finite electric resistance and may be locally differentially elastic.

Differential local conductivity of the interlayers 34 may be provided through use of recesses 46 contained within the interlayers 34 or by other techniques known in the art. Any number of recesses may be used and they may be of various sizes, shapes, and be in various arrangements known in the art.

Electrical resistance of the test layers 32 and/or the interlayers 34 changes when a force or a load is applied on the sensor 14. The electrical resistance of the test layers 32 and/or the interlayers 34 may also change due to change in thermal conditions of materials contained therein. The magnitude of the changes in electrical resistance is in response to changes in loading conditions.

Also, as load is applied and the sensor is in a state of elongation, compression, flexion, or a combination thereof, changes in traveling distances of current passing between the electrodes 36 is translated into directly related variations in current amplitude and signal wavelength. The variations in signal current amplitude and wavelength aid in differentiating the nature and action of the applied load including the above mentioned states.

Distributed changes in resistance of the test layers 32 and the interlayers 34 provide information concerning the nature and distribution of applied forces. For example, when surface 48 of the seat pan 18, of FIG. 1, is not loaded uniformly but rather locally, such as when an occupant is in a kneeling position as opposed to a seated position on the seat pan 18, the sensor 14 is flexed. In this example, flexion refers to elongation of lower test layers, such as elongation of the test layer 42, and localized compression of upper test layers, such as localized compression of the upper layer 40.

Elongation of material leads to a reduced cross-sectional area and hence to a stretching of the material, resulting in increased electrical resistance. On the other hand, a material compression can lead to a thickening of cross-sectional area and a shrinking of the material, resulting in reduced electrical resistance.

When a force or load is not applied on the sensor 14 and electrical conductivities of the upper layer 40 and of the bottom layer 42 are different then when a force is applied on the sensor 14, resulting variation in resistance is clearly attributed to tensile stresses, compressive stresses, or convex or concave flexions.

The electrodes 36 are coupled to one or more outer surfaces 50 of the test layers 32. The electrodes 36 extend from the surfaces 50 and have a separation distance 52 therebetween. The electrodes 36 may be coupled to and arranged on the outer surfaces 50 using various techniques known in the art. An example of one such arrangement, of the electrodes 36, is illustrated in FIG. 4. Although only two electrodes are shown as being coupled to a lower outer surface 54 of the bottom layer 42, in the embodiments of FIGS. 2 and 4 the electrodes may be coupled in other various arrangements; one such arrangement is illustrated in FIG. 3.

The housing 38 includes multiple insulting layers 56 that may form an insulated boundary or periphery 58 surrounding the plate 30, as shown. The insulating layers 56 may be formed of polyurethane, polyester, or some other flexible material. The periphery 58 may be configured to compress and have “V”-shaped ends 59 so as to fold and aid in compliance and flexibility of the sensor 14. Of course, other housing or boundary arrangements and configurations may be envisioned and utilized by one skilled in the art.

Referring now to FIG. 3, a cross-sectional view of a mechanical stress detection and characterization sensor 14′ in accordance with multiple embodiments of the present invention is shown.

In a first embodiment of FIG. 3 a first pair of electrodes 60 are coupled to an upper surface 62 of a first test layer 40′ and a second pair of electrodes 64 are coupled to a bottom surface 54′ of a second test layer 42′, as is shown in FIG. 3. By having a pair of electrodes, such as electrodes 60 and 64, coupled to each of the test layers 40′ and 42′, electrical variations of each test layer may be determined separately and compared. Individual test layer monitoring allows the present invention to monitor varying flexion applied forces.

In a second embodiment of FIG. 3, the electrodes 60 and 64 are arranged such that they are opposing each other on mutually opposing surfaces, also as shown in FIG. 3. For example, electrode 66 on upper surface 64 opposes electrode 68 on the bottom surface 54′. A force that is applied in a direction perpendicular to axis 44′ may then be detected, independently of bending or flexion type stresses. Note that electrodes 60 and 64 may be on opposing test layers, but not be arranged as to be directly opposing each other.

In another embodiment of FIG. 3, the above first and second embodiments are combined. Combination thereof provides electrodes on each test layer and arrangement of the electrodes such that they oppose each other on mutually opposing surfaces, again as shown in FIG. 3. The combination allows both flexion and compression forces to be measured.

Referring now to FIG. 4, a top view of a pair of meandering electrodes 70 are shown as being coupled to a test layer 72 of a mechanical stress detection and characterization sensor 14″ and in accordance with another embodiment of the present invention. The electrodes 70 are meanderingly applied to an outer surface 76 of the test layer 72. Meanderly applied electrodes aids in providing a highly extensible stress detection sensor and for the sensor to be elongated, compressed, and flexed without being impeded by the electrodes.

Although, in the embodiments of FIGS. 2-4, the electrodes 36, 60, 64, and 70 are flat and rectangular in shape and formed of copper, the electrodes may be of various shapes, styles, and are formed of various conductive materials known in the art. The electrodes 36, 60, 64, and 70 may have a conductive coating, such as a varnish coating. The flat shape, copper material, and conductive coating of the electrodes 36, 60, 64, and 70 aid in conductivity of the electrodes 36, 60, 64, and 70 and passage of current between the electrodes 36, 60, 64, and 70 and test plates, such as plate 30. The electrodes 36, 60, 64, and 70 may be a part of a conductive cable, such as cable 15.

The present invention provides stress detection and characterization system that provides information related to nature of applied forces and changes in those applied forces over a large surface area. The present invention is versatile, simple to implement, easy to fabricate, cost effective, and provides improved discrimination of applied forces and resulting stresses. The system detects and characterizes the applied forces through simple monitoring of variations in resistance.

While the invention has been described in connection with one or more embodiments, it is to be understood that the specific mechanisms and techniques which have been described are merely illustrative of the principles of the invention, numerous modifications may be made to the methods and apparatus described without departing from the spirit and scope of the invention as defined by the appended claims.

What is claimed is:

1. A mechanical stress detection and characterization sensor comprising:
a plurality of test layers at least partially overlapping each other; and
a plurality of electrodes electrically coupled to said plurality of test layers;
wherein electrical properties of at least one test layer of said plurality of test layers changes in response to loading of the mechanical stress detection and characterization sensor.

2. A sensor as in claim 1 wherein said plurality of test layers form a detection plate.

3. A sensor as in claim 1 wherein nonoverlapping portions of said plurality of test layers comprise at least portions of said plurality of electrodes.

4. A sensor as in claim 1 wherein said plurality of test layers have at least one common material property.

5. A sensor as in claim 1 wherein said plurality of test layers have different material properties selected from at least one of electrical conductivity, modulus of elasticity, flexural rigidity, and variation of specific electrical conductivity under force, loading, or thermal conditions.

6. A sensor as in claim 1 wherein said plurality of test layers change in electrical conductivity with change in applied force, supporting load, or thermal conditions.

7. A sensor as in claim 1 further comprising at least one interlayer disposed between said plurality of test layers.

8. A sensor as in claim 7 wherein said at least one interlayer varies in electrical conductivity under a load directed perpendicular to said plurality of test layers.

9. A sensor as in claim 7 wherein said at least one interlayer is locally differentially electrically conductive.

10. A sensor as in claim 7 wherein said at least one interlayer is locally differentially elastic.

11. A sensor as in claim 7 wherein said at least one interlayer is electrically more conductive in a direction perpendicular to said plurality of test layers than in a direction parallel with said plurality of test layers.

12. A sensor as in claim 7 wherein said at least one interlayer comprises at least one recess.

13. A sensor as in claim 1 further comprising an interlayer coupled between a first test layer and a second test layer of said plurality of test layers.

14. A sensor as in claim 1 further comprising a plurality of insulating layers insulating said plurality of test layers.

15. A sensor as in claim 14 wherein said plurality of insulating layers forms an insulating boundary around said plurality of test layers.

16. A sensor as in claim 15 wherein said insulating boundary is flexible.

17. A sensor as in claim 14 wherein said plurality of insulating layers are in a compressible configuration.

18. A sensor as in claim 15 wherein at least a portion of said plurality of electrodes is enveloped within said insulating boundary.

19. A sensor as in claim 1 wherein said plurality of electrodes are at least partially coated in an electrically conductive material.

20. A sensor as in claim 1 wherein said plurality of electrodes are in the form of at least one flat cable.

21. A sensor as in claim 1 wherein at least one electrode in said plurality of electrodes is at least partially arranged as to be meandering across said plurality of test layers.

22. A sensor as in claim 1 wherein at least two electrodes of said plurality of electrodes are directly coupled to each of said plurality of test layers.

23. A sensor as in claim 1 wherein said plurality of electrodes are coupled to mutually opposed surfaces of said plurality of test layers.

24. A mechanical stress detection and characterization system comprising:
a plurality of test layers at least partially overlapping each other;
a plurality of electrodes electrically coupled to said plurality of test layers; and
a controller electrically coupled to said plurality of electrodes detecting and characterizing loading of the mechanical stress detection and characterization sensor in response to change in electrical properties of at least one test layer of said plurality of test layers.

25. A seat system comprising:
a mechanical system; and
a mechanical stress detection and characterization sensor coupled to said mechanical system and comprising;
a plurality of test layers at least partially overlapping each other; and
a plurality of electrodes electrically coupled to said plurality of test layers;
wherein electrical properties of at least one test layer of said plurality of test layers changes in response to loading of the mechanical stress detection and characterization system.
